(19) United States
(12) Patent Application Publication
(10) Pub. No.: US 2002/0022902 A1
(43) Pub. Date: Feb. 21, 2002

(54) Visibility enhancement system for a CNC machine center

(76) Inventor: Gregory A. Peek, Castle Rock, CO (US)

Correspondence Address: CHARLES C. LOGAN II, 8282 UNIVERSITY AVENUE, LA MESA, CA, 91941, US

(21) Appl. No.: 09/932,401

(22) Filed: Aug. 17, 2001

Related U.S. Application Data
(60) Provisional application No. 60/226,021, filed on Aug. 18, 2000.

(51) Int. Cl. G06F 19/00; B60S 1/14; B60S 1/18; B60S 1/56

(52) U.S. Cl. 700/159; 15/250.3; 15/250.28; 15/250.18

(57) ABSTRACT

A visibility enhancement system for a CNC machine center that incorporates a windshield wiper assembly. The CNC machine center has a door with a window for viewing machining operations therein. The windshield wiper arm and its wiper blade are mounted on the inner surface of the window in the door. The windshield wiper assembly has structure on the outer surface of the door for reciprocally rotating the windshield wiper arm back and forth through a predetermined angle. The windshield wiper assembly has spring means for constantly pressing the wiper blade against the inner surface of the window. The windshield wiper arm has an adjustable length arm that allows different lengths of wiper blades to be used.

This patent application claims the priority of provisional application number 60/226,021 filed Aug. 18,2000.

### BACKGROUND OF THE INVENTION

The invention relates to a CNC machine center and more specifically to a visibility enhancement system that allows the inner surface of a window in a door to be periodically wiped clean thereby allowing a person on the outside of the door to view the machining operations taking place inside the CNC machine center.

Modern machinery used in the metal removal areas of manufacturing, especially CNC machine centers are automated, enclosed machines that require the operator to be outside the machine enclosure during operation. These machines commonly have enclosures around the working area for a number of reasons: 1) safety, to protect the operator. Also the machines have electrical interlocks to restrict the machine from running in an automatic or full speed mode while the doors to the enclosure are not completely closed. 2) These machines typically have a coolant or lubricant flooding the work area during operation to lubricate and cool the cutting tool and to wash chips away from the cutting area as well.

The enclosure of these machine tools have windows in the walls of the enclosure to allow the operator to view inside the enclosure while the machine is running. The windows become covered with splashing coolant, which is typically water-soluble oil with a milky appearance, while running. The coolant splashing on the windows makes it difficult if not impossible to see what is happening in the interior of the machine while running. There is a need at times to be able to see what is happening inside of the enclosure while the machine is running. Without the ability to see inside, there are a number of things which can go wrong that could result in broken tools, scraped parts, or damaged machines or fixtures. Any of these could be costly, and should be avoidable.

Presently, one mechanical device that allows the operator to see past the coolant on the interior side of the window is a “spin disc,” or sometimes called a “Visiport.” The spin disc is a circular glass or a plastic wheel mounted about an axle and powered by either an electric or pneumatic motor. The disc rotates at a high enough RPM to spin coolant off, giving the appearance of a clear window. The spinning disc is used in other applications including marine use to clear fog, rain, or saltwater spray from the cockpit windows of ships, and has been in existence for marine use since 1938, from Speich, an Italian Company located in Genoa, Italy.

“This Visiport” is believed to be from a German Company, and is distributed for manufacturer for machine tool use in the U.S. by Tooling 2000 located in Redmond, Wash. The Visiport type of product is limited in size by the diameter of the disc and the rotating masks. They are believed to be available only in 20 and 25-cm diameters. These products are very expensive. The disadvantages of a spin disc are: purchase cost, cost of installation for retrofit applications (this could involve interfacing with the machine control systems), and power consumption of either compressed air or electricity.

The second prior art type of device is an air blast. This is a nozzle spraying compressed air at the window. The drawbacks to this are the limited area that the stream of high-pressure air, approximately 100 psi, will cover, as well as the expense of compressed air consumption with an open nozzle for the time it would be blasting the window.

It is an object of the invention to provide a novel visibility system for a CNC machine center that is relatively inexpensive.

It is also an object of the invention to provide a novel visibility system for a CNC machine center that is easily and quickly installed.

It is another object of the invention to provide a novel visibility system for a CNC machine center that requires no retrofit applications involving the machines control system.

It is an additional object of the invention to provide a novel visibility system for a CNC machine center that requires neither a power consumption of either compressed air nor electricity.

It is a further object of the invention to provide a novel visibility system for a CNC machine center that requires only a minimal number of small holes to be formed in the door to mount a manually operable windshield wiper assembly.

### SUMMARY OF THE INVENTION

The invention is a cost-effective means of temporarily clearing the coolant from the inside of the windows. It's cost is considerably lower than spin discs both in the initial investment and in installation. The invention consists of a windshield wiper assembly having a wiper blade, a windshield wiper arm, a spindle and spindle housing, and a crank arm for causing the spindle to rotate. The spindle housing is mounted through the wall of the CNC machine center in an aperture or apertures created during the installation process. The spindle housing is then connected to the enclosure wall with a fastener or fasteners.

The spindle mounts inside the spindle housing in a pair of opposed anti-friction devices, and is free to rotate about its axis. At one end of the spindle on the interior of the machine is an arm attached at one end in a nonrotatable manner. This arm has a windshield wiper arm mounted to its opposite end. The windshield wiper arm is free to rotate about one axis, which is perpendicular to the longitudinal axis of the arm. This allows the wiper to float, compensating for angular misalignment between the longitudinal axis of the arm and the interior surface of the window. The wiper blade will lay flat, contacting the window for its entire length. The wiper blade is made of a soft material, which will scrape across the surface of the window as the spindle is rotated and displace the liquid, which may obscure visibility into the machine.

In operation, the operator will hold the knob on the end of the crank arm in one hand and cause the spindle to rotate a variable number of degrees causing the windshield wiper arm and wiper blade to move back and forth across the window as may be required to displace the liquid and observe the interior of the machine during operations.

### DESCRIPTION OF THE DRAWINGS

FIG. 1 is a front perspective view of a CNC machine center illustrating a door having a viewing window and showing the windshield wiper assembly installed on the door;

FIG. 2 is a front perspective view of the windshield wiper assembly as assembled but having the door removed for clarity;

FIG. 3 is an exploded side elevation view of the windshield wiper assembly with portions broken away for clarity; and

FIG. 4 is a cross-sectional view along lines 44 of FIG. 2 illustrating the cylindrically shaped spindle housing.

### DESCRIPTION OF THE PREFERRED EMBODIMENT

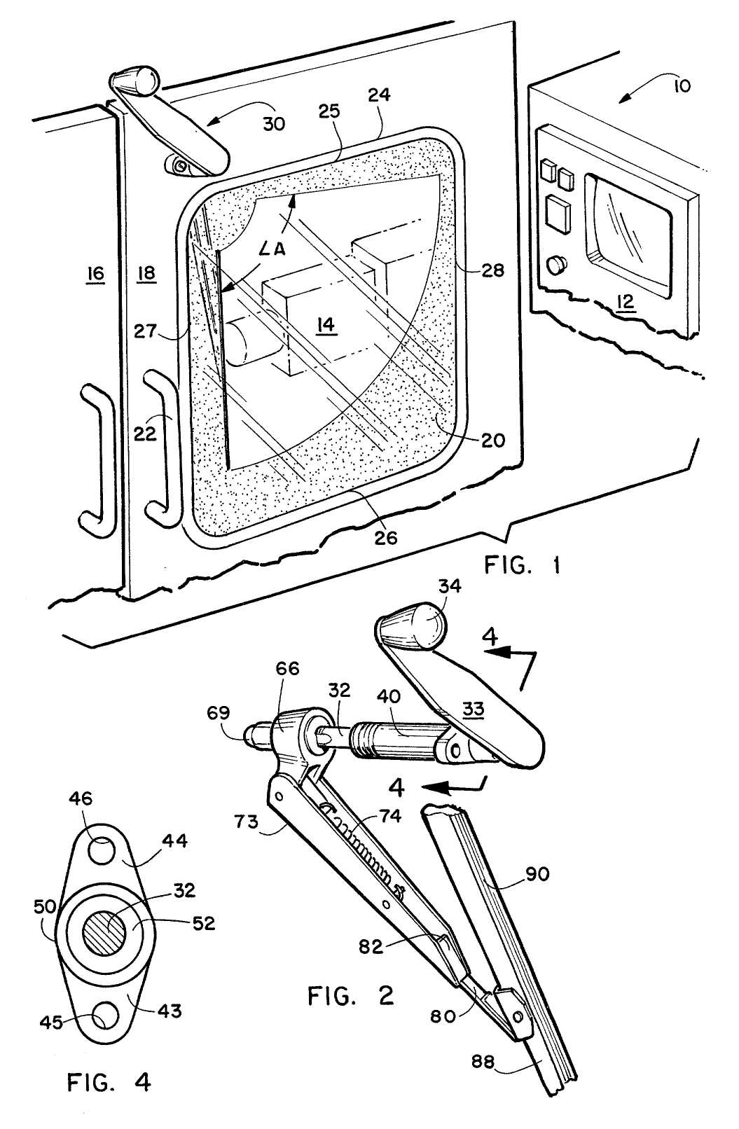

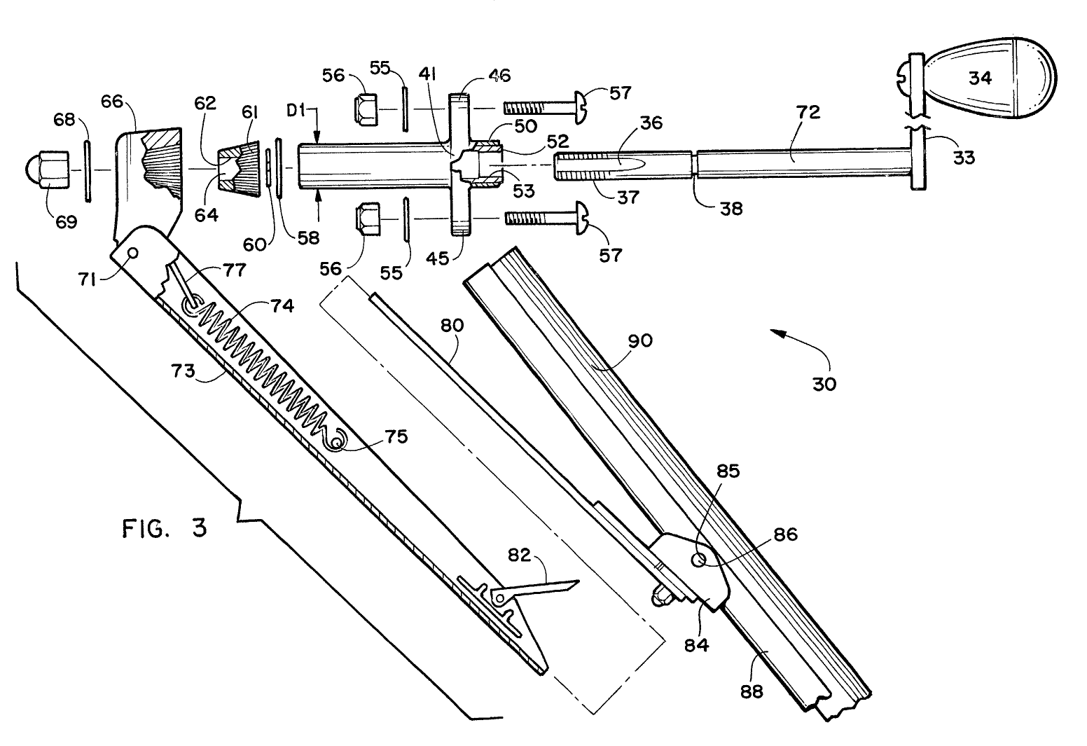

The visibility enhancement system for a CNC machine center will now be described by referring to FIGS. 1-4 of the drawings. The CNC machine center is generally designated numeral 10. It has a console 12, a CNC cutting machine 14, a door 16 and a door 18. Door 18 has a window 20 and a handle 22. Window 20 has a peripheral edge 24 having a top edge 25, a bottom edge 26, a left edge 27 and a right edge 28. A windshield wiper assembly 30 is mounted adjacent the intersection of top edge 25 and left edge 27.

The structure of the windshield wiper assembly 30 and the manner in which it is mounted on door 18 is best understood by referring to FIGS. 2-4. It has an elongated spindle or shaft 32 having a crank arm 33 secured to its front end. A knob 34 is secured to crank arm 33. The rear end of spindle 32 has a pair of diametrically opposed flat sections 36 that are interspersed by external threads 37. A snap ring groove 38 is located intermediate the length of spindle 32. The function of these elements will be described later.

A cylindrically-shaped spindle housing has a flange 41 adjacent its front end having ring shaped flange portions 43 and 44. The wing-shaped flange portions 43 and 44 have respective apertures 45 and 46 passing therethrough. Cylindrically-shaped spindle housing 40 has a diameter DI and a neck portion 50. It has a bushing 52 having a bore hole 53. Spindle 32 is journaled in bushing 52 so that it rotates freely. Spindle housing 40 is installed in door 18 by drilling a hole from its outer surface all the way through to its inner surface. This hole would have a diameter slightly larger than D1 so that it is easily insertable therein. Laterally spaced holes would be drilled through door 18 to align with the apertures 45 and 46 in flange 41. Washers 55 and nuts 56 would be screwed onto the ends of a screws 57 to keep spindle housing 40 stationary and prevent spindle housing 40 from rotating. A flat washer 58 is inserted over the rear end of spindle 32 as it passes through spindle housing 40 and a snap ring 60 would be inserted into snap ring groove 38. The rear end of spindle 32 also passes through a bore hole 62 in a tapered splined sleeve 61 that internal is diametrically opposed flat surface areas 64 that mate with the flat portions 36 on spindle 32 so that rotation of spindle 32 also causes rotation of tapered splined sleeve 61. Spindle arm 66 has a splined bore 68 that mates with the splines on the outer surface of tapered spine sleeve 61. Spindle arm 66 also has a bore hole in its rear end that allows the front end of spindle 32 to pass therethrough and a lock washer 68 and a castle nut 69 are screwed on to its end.

A pivot pin 71 secures windshield wiper arm 73 to spindle arm 66. A coil spring 74 has its one end captured by a pin 75. The opposite end of coil spring 74 is secured to a link 77 whose other end is secured to spindle arm 66 and that applies a spring tension causing the windshield wiper arm 73 to be pressed against the inner surface of window 20. A length adjustment arm 80 can have its length adjusted by locking lever 82 so that different lengths of wiper blades can be utilized. A bracket 84 is mounted adjacent the front end of adjustable length arm 80 and it has diametrically opposed apertures 85 that receive pins 86 extending outwardly from blade frame 88 that holds the wiper blade 90.

FIG. 1 shows that window 20 has a film of lubricants and machine cuttings sprayed against its inner surface. The path of wiper blade 90 over the inner surface of window 20 shows how the visibility is dramatically improved thereby allowing a person on the outside of door 18 to view the machining operations in the CNC machine center. A person can continually crank arm 33 up and down through an angle A that is approximately 90° to provide a clear area on the inside surface of the window. It is understood that a D.C. motor or a pneumatic motor could be utilized to reciprocally rotate spindle 32 back and forth through the predetermined angle A.

In the claims:

1. A method of installing a visibility enhancement system on a door window of a CNC machine center comprising the following steps:
a) providing a CNC machine center having a door with a window for viewing machining operations therein; said door and window each having an outer surface and an inner surface; said window having a peripheral edge;
b) providing a windshield wiper assembly having an elongated spindle housing, an elongated spindle, a spindle arm having a front end and a rear end, a windshield wiper arm and a wiper blade; said elongated spindle housing having a front end, a rear end, a diameter D1, a flange adjacent said front end and a bore hole extending from said front end through to said rear end;
c) forming a hole in said door at a predetermined location adjacent said peripheral edge of said window;
d) inserting said elongated spindle housing into said hole in said door from said outer surface of said door;
e) fastening said flange of said elongated spindle housing to said outer surface of said door;
f) inserting said rear end of said spindle through said bore of said elongated spindle housing;
g) attaching said spindle arm on said rear end of said spindle so that said wiper blade is properly positioned on said inner surface of said window.

2. A method as recited in claim 1 wherein said front end of said spindle has means for reciprocally rotating said windshield wiper arm back and forth through a predetermined angle A.

3. A method as recited in claim 2 wherein said means for rotating said windshield wiper arm is a crank arm secured to said front end of said spindle.

4. A method as recited in claim 2 wherein said angle A is approximately 90°.

5. A method as recited in claim 2 wherein said windshield wiper arm has an adjustable length arm that allows different lengths of blades to be mounted on said windshield wiper arm.

6. A combination structure of a CNC machine center and a windshield wiper assembly comprising:
a CNC machine center having a door with a window for viewing machining operations therein; said door and window each having an outer surface and an inner surface;
a windshield wiper assembly comprising a windshield wiper arm, a wiper blade, said wiper blade being properly positioned on said inner surface of said window, and means for reciprocally moving said windshield wiper arm back and forth to wipe a predetermined portion of said inner surface of said window; and
means mounting said windshield wiper assembly on said door.

7. The combination structure as recited in claim 6 wherein said means for reciprocally moving said windshield wiper arm back and forth comprises a crank arm positioned adjacent said outer surface of said door.

8. The combination structure as recited in claim 7 wherein said crank arm has an inner end and an outer end and a knob is mounted adjacent said outer end so that a person can manually move said crank arm back and forth.

9. The combination structure as recited in claim 7 wherein said windshield wiper assembly further comprises spring means for constantly pressing said wiper blade against said inner surface of said window.

10. The combination structure as recited in claim 9 wherein said windshield wiper arm has a length adjustment arm that allows different lengths of wiper blades to be used.
